(19) United States
(12) Patent Application Publication
(10) Pub. No.: US 2022/0002476 A1
(43) Pub. Date: Jan. 6, 2022

(54) METHOD FOR PREPARING A POLYESTER OF THE POLY(1,4:3,6-DIANHYDROHEXITOL-COCYCLOHEXYLENE TEREPHTHALATE) TYPE

(71) Applicant: ROQUETTE FRERES, Lestrem (FR)

(72) Inventors: René SAINT-LOUP, LOMME (FR); Nicolas JACQUEL, LAMBERSART (FR); Nicolas DESCAMPS, SAINGHIN-EN-MELANTOIS (FR)

(21) Appl. No.: 17/281,664

(22) PCT Filed: Oct. 2, 2019
(86) PCT No.: PCT/FR2019/052331

§ 371 Date: Mar. 31, 2021

(51) Int. Cl. C08G 63/183; C08L 67/03; B29C 48/00

(52) U.S. Cl. CPC C08G 63/183; B29K 2067/00; B29C 48/022; C08L 67/03

(57) ABSTRACT

The invention relates to a method for preparing a polyester of the poly(1,4:3,6-dianhydrohexitol-cocyclohexylene terephthalate) type using at least one nucleating agent. The invention also relates to a composition comprising a polyester of the poly(1,4:3,6-dianhydrohexitol-cocyclohexylene terephthalate) type and at least one nucleating agent as well as to a finished or semi-finished plastic article comprising the composition according to the invention.

### FIELD OF THE INVENTION

The invention relates to the field of polymers and relates very particularly to an improved process for the preparation of polyesters comprising 1,4:3,6-dianhydrohexitol units employing at least one nucleating agent. The invention also relates to a composition comprising a polyester comprising 1,4:3,6-dianhydrohexitol units and at least one nucleating agent. Another subject matter of the invention relates to a finished or semifinished plastic article comprising the composition according to the invention.

### TECHNICAL BACKGROUND OF THE INVENTION

Polyethylene terephthalate (PET) is a polyester comprising ethylene glycol and terephthalic acid units, used for example in the manufacture of containers, packaging, films or also fibers.

However, for certain applications or under certain conditions of use, these polyesters do not exhibit a satisfactory level of performance, in particular in terms of optical properties, of impact strength or also of thermal resistance. In order to overcome these disadvantages, glycol-modified PETs (PET-Gs) have been developed. These are polyesters comprising, in addition to the ethylene glycol and terephthalic acid units, cyclohexanedimethanol (CHDM) units. The introduction of this diol into the PET makes it possible to adjust the properties to the intended application, for example to improve its impact strength or its optical properties, in particular when the PET-G is amorphous.

Other modified PETs have also been developed by introducing 1,4:3,6-dianhydrohexitol units, in particular isosorbide units, into the polymer chain. This is poly(ethylene-co-isosorbide terephthalate) or PEIT. These modified polyesters exhibit higher glass transition temperatures than unmodified PETs or than PET-Gs comprising CHDM. In addition, 1,4:3,6-dianhydrohexitols exhibit the advantage of being able to be obtained from renewable resources, such as starch. These modified polyesters are useful in particular in the manufacture of bottles, films, thick sheets, fibers or articles requiring elevated optical properties.

Finally, a new category of polyesters based on isosorbide and incorporating CHDM units has emerged: poly(isosorbide-co-cyclohexylene terephthalate)s or PIT-Gs. Just like their PEIT homologs, they exhibit a higher glass transition temperature than those relating to PET and to PET-G. In terms of order of magnitude, the glass transition temperature is increased by approximately 2° C. per mol % of isosorbide incorporation with regard to all of the monomers. In addition, PIT-Gs also exhibit the additional advantages of exhibiting only a very slight coloration and good impact strength properties, in particular under cold conditions. PIT-Gs have in particular been described and claimed in the patent application WO 2016/189239 A1. The latter discloses a process for the manufacture of a polyester comprising at least one 1,4:3,6-dianhydrohexitol unit, at least one alicyclic diol unit (B) other than the 1,4:3,6-dianhydrohexitol units and at least one terephthalic acid unit, said polyester being devoid of noncyclic aliphatic diol units or comprising a small molar amount of noncyclic aliphatic diol units.

Polyesters containing isosorbide, and in particular PIT-Gs, are conventionally produced by the molten route. However, this synthesis technique makes it difficult to achieve the high molar masses required for applications requiring significant mechanical properties or high melt viscosities necessary for the transformation and forming of these polymers. For semicrystalline polyesters, higher molar masses can be obtained by carrying out a solid-state postcondensation (SSPC) of the polymer. This is the process conventionally used to obtain PETs intended for the manufacture of fibers or bottles. SSPC makes it possible to continue the chain-growth reaction, but on granules in the solid state. To do this, the granules must first of all be crystallized in order to avoid the formation of aggregates at high temperature and for the purpose of concentrating the chain ends in the amorphous domains.

In the case of isosorbide-based copolymers, the crystallization rate is considerably slowed down: for 15 mol % of isosorbide incorporation with respect to all the monomers, the crystallization time of a CHDM homopolymer, which is initially less than one minute minutes, becomes greater than 8 hours. This slowing down has a direct and not insignificant impact on the productivity of the overall manufacturing process. It is also the cause of the formation of agglomerates which can, depending on their size (sometimes of the order of several centimeters), bring about blockages in the hoppers used in the forming installations. This results in a shutdown of the process in order for the installations to be cleaned, sometimes by means of a rudimentary tool, such as the use of hammers, which also leads to a not insignificant loss of material. By slowing down the crystallization kinetics, other disadvantages are also generated at the forming step. In injection molding, for example, it then becomes necessary to keep the part longer in the mold at high temperature.

Moreover, if it were desired not to bring the crystallization to completion in order to avoid or limit the abovementioned effects, there would be a risk of new problems: by way of example, the mechanical and thermal (lower Tg) properties of the final material may be affected by a lack of crystallinity. Finally, for the manufacture of bottles, a lower crystallinity has a negative effect on the barrier properties (less tortuosity).

Thus, there is still a need to develop a novel process making it possible to accelerate the rate of crystallization of polyesters comprising 1,4:3,6-dianhydrohexitol units, in particular isosorbide units, such as poly(isosorbide-co-cyclohexylene terephthalate) or PIT-G.

It is to the credit of the applicant company to have developed, via specific conditions, and inter alia by the use of nucleating agents, a process making it possible to solve this problem.

### SUMMARY OF THE INVENTION

A subject matter of the invention is thus a process for the preparation of a polyester of poly(1,4:3,6-dianhydrohexitol-co-cyclohexylene terephthalate) type, said process comprising:
a) a step of synthesis of said polyester by oligomerization and then polycondensation;
b) a step of recovery of the polyester;
c) an optional step of extrusion of said polyester;
d) a step of solid-phase postcondensation SPPC of said polyester;

characterized in that said process additionally comprises at least one step of addition of at least one nucleating agent.

According to two major alternative forms of the invention, the nucleating agent is added during step a) or during step c) when the latter is not optional. In both scenarios, it appears, surprisingly, that the crystallization time of the poly(1,4:3,6-dianhydrohexitol-co-cyclohexylene terephthalate) is greatly reduced, in comparison with that of the same polyester synthesized in the absence of nucleating agent. In addition, the use of the nucleating agent prevents the formation of agglomerates during the step of postcondensation by SSPC. Finally, the mechanical, thermal and optical properties of the synthesized polyester are not affected by the use of this nucleating agent.

The invention also relates to a composition comprising a polyester of poly(1,4:3,6-dianhydrohexitol-co-cyclohexylene terephthalate) type and at least one nucleating agent.

Another subject matter of the invention relates to a finished or semifinished plastic article comprising the composition according to the invention.

### DETAILED DESCRIPTION OF THE INVENTION

A subject matter of the invention is a process for the preparation of a polyester of poly(1,4:3,6-dianhydrohexitol-co-cyclohexylene terephthalate) type exhibiting reduced crystallization kinetics. This process is in particular characterized in that it comprises at least one step of introduction of a nucleating agent.

A subject matter of the invention is thus a process for the preparation of a polyester of poly(1,4:3,6-dianhydrohexitol-co-cyclohexylene terephthalate) type comprising:
a) a step of synthesis of said polyester, by oligomerization and then polycondensation;
b) a step of recovery of the polyester;
c) an optional step of extrusion of said polyester;
d) a step of solid-phase postcondensation (SSPC) of said polyester;

characterized in that said process additionally comprises at least one step of addition of at least one nucleating agent.

Advantageously, the solution reduced viscosity [35° C.; ortho-chlorophenol; 5 g of polyester/I] of said polyester is greater than 50 ml/g.

Unexpectedly, according to the process of the invention, it is quite possible to accelerate the crystallization of polyesters comprising 1,4:3,6-dianhydrohexitol units. The process of the invention makes it possible to prevent the coalescence of the granules during the solid-state postcondensation treatment of the polymers, which also makes it possible to reduce the time required for the crystallization step.

It is to the credit of the applicant company to have demonstrated that the process of the invention makes it possible to prepare polyesters comprising 1,4:3,6-dianhydrohexitol units with which, during the forming, the cycle times during the injection molding of parts are reduced, and the mechanical and physical properties, such as the mechanical properties of yarns or also the barrier properties of bottles, are improved.

Synthesis Step a)

The synthesis of the polyester is generally carried out starting from at least one 1,4:3,6-dianhydrohexitol (A), at least one alicyclic diol (B) other than 1,4:3,6-dianhydrohexitols (A) and at least one terephthalic acid (C). The molar ratio ((A)+(B))/(C) advantageously ranging from 1.05 to 1.5, said monomers being devoid of noncyclic aliphatic diol or comprising, with respect to all the monomers introduced, a molar amount of noncyclic aliphatic diol units of less than 5%.

A noncyclic aliphatic diol can be a linear or branched noncyclic aliphatic diol. It can also be a saturated or unsaturated noncyclic aliphatic diol. Besides ethylene glycol, the saturated linear noncyclic aliphatic diol can, for example, be 1,3-propanediol, 1,4-butanediol, 1,5-pentanediol, 1,6-hexanediol, 1,8-octanediol and/or 1,10-decanediol. Mention may be made, as examples of saturated branched noncyclic aliphatic diol, of 2-methyl-1,3-propanediol, 2,2,4-trimethyl-1,3-pentanediol, 2-ethyl-2-butyl-1,3-propanediol, propylene glycol and/or neopentyl glycol. Mention may be made, as example of unsaturated aliphatic diol, for example, of cis-2-butene-1,4-diol.

This molar amount of noncyclic aliphatic diol unit is advantageously less than 1%. Preferably, the polyester is devoid of noncyclic aliphatic diol unit.

In a more detailed way, step a) of synthesis of the polyester can comprise:
a1) a step of introduction, into a reactor, of monomers comprising at least one 1,4:3,6-dianhydrohexitol (A), at least one alicyclic diol (B) other than 1,4:3,6-dianhydrohexitols (A) and at least one terephthalic acid (C), the molar ratio ((A)+(B))/(C) ranging from 1.05 to 1.5, said monomers being devoid of noncyclic aliphatic diol or comprising, with respect to all the monomers introduced, a molar amount of noncyclic aliphatic diol units of less than 5%;
a2) a step of introduction of a catalytic system into the reactor;
a3) a step of polymerization of said monomers in order to form the polyester, said step consisting of:
   a first stage of oligomerization during which the reaction medium is stirred under an inert atmosphere at a temperature ranging from 265 to 280° C., advantageously from 270 to 280° C., for example 275° C.;
   a second stage of condensation of the oligomers during which the oligomers formed are stirred under vacuum at a temperature ranging from 265 to 300° C. in order to form the polyester, advantageously from 280 to 290° C., for example 285° C.

This first stage of oligomerization is carried out in an inert atmosphere, that is to say under an atmosphere of at least one inert gas. This inert gas can in particular be molecular nitrogen. This first stage can be carried out under a gas stream. It can also be carried out under pressure, for example at a pressure of between 1.05 and 8 bar.

Preferably, the pressure ranges from 3 to 8 bar, very preferentially from 5 to 7.5 bar, for example 6.6 bar. Under these preferred pressure conditions, the reaction of all the monomers with one another is promoted while limiting the loss of monomers during this stage.

Prior to the first oligomerization stage, a step of deoxygenation of the monomers is preferentially carried out. It can be carried out, for example, by producing, after having introduced the monomers into the reactor, a vacuum and by then introducing an inert gas, such as nitrogen, into the reactor. This cycle of vacuum-introduction of inert gas can be repeated several times, for example from 3 to 5 times. Preferably, this vacuum-nitrogen cycle is carried out at a temperature between 60 and 80° C. in order for certain reactants, and in particular the diols, to have completely melted. This deoxygenation stage exhibits the advantage of improving the coloring properties of the polyester obtained at the end of the process.

The second stage of condensation of the oligomers is carried out under vacuum. The pressure can decrease continuously during this second stage by using pressure decrease gradients, in stationary phases, or also by using a combination of pressure decrease gradients and stationary phases. Preferably, at the end of this second stage, the pressure is less than 10 mbar, very preferentially less than 1 mbar.

According to this embodiment, the first stage of the polymerization step preferably has a duration ranging from 20 minutes to 5 hours. Advantageously, the second stage has a duration ranging from 30 minutes to 6 hours, the start of this stage consisting of the moment when the reactor is placed under vacuum, that is to say at a pressure of less than 1 bar.

The process according to this embodiment comprises a step of introduction of a catalytic system into the reactor. This step can take place prior to or during the polymerization step described above.

Within the meaning of the present invention, “catalytic system” is understood to mean a catalyst or a mixture of catalysts, which is/are optionally dispersed or fixed to an inert support.

The catalyst is used in amounts suitable for obtaining a high-viscosity polymer in accordance with the invention.

An esterification catalyst is advantageously used during the oligomerization stage. This esterification catalyst can be chosen from tin, titanium, zirconium, hafnium, zinc, manganese, calcium or strontium derivatives, organic catalysts, such as para-toluenesulfonic acid (PTSA) or methanesulfonic acid (MSA), or a mixture of these catalysts. Mention may be made, by way of example of such compounds, of those given in the application US2011282020A1 in sections [0026] to [0029], and on page 5 of the application WO 2013/062408 A1.

Preferably, a titanium derivative, a zinc derivative or a manganese derivative is used during the first transesterification stage.

Use may be made, by way of example of amounts by weight, of 10 to 500 ppm of catalytic system during the oligomerization stage, with respect to the amount of monomers introduced.

At the end of transesterification, the catalyst of the first step can be optionally blocked by the addition of phosphorous acid or of phosphoric acid, or else, as in the case of tin(IV), reduced by phosphites, such as triphenyl phosphite or tris(nonylphenyl) phosphites or those mentioned in section [0034] of the application US2011282020A1.

The second stage of condensation of the oligomers can optionally be carried out with the addition of a catalyst. This catalyst is advantageously chosen from tin, preferably tin, titanium, zirconium, germanium, antimony, bismuth, hafnium, magnesium, cerium, zinc, cobalt, iron, manganese, calcium, strontium, sodium, potassium, aluminum or lithium derivatives or a mixture of these catalysts. Examples of such compounds can, for example, be those given in the patent EP 1 882 712 B1 in sections [0090] to [0094].

Preferably, the catalyst is a tin, titanium, germanium, aluminum or antimony derivative.

Use may be made, by way of example of amounts by weight, of 10 to 500 ppm of catalytic system during the stage of condensation of the oligomers, with respect to the amount of monomers introduced.

Very preferentially, a catalytic system is used during the first stage and the second stage of polymerization. Said system is advantageously constituted by a catalyst based on tin or by a mixture of catalysts based on tin, on titanium, on germanium and on aluminum.

Use may be made, by way of example, of an amount by weight of 10 to 500 ppm of catalytic system, with respect to the amount of monomers introduced.

According to the process of this embodiment, an antioxidant is advantageously used during the step of polymerization of the monomers. These antioxidants make it possible to reduce the coloration of the polyester obtained. The antioxidants may be primary and/or secondary antioxidants. The primary antioxidant can be a sterically hindered phenol, such as the compounds HOSTANOX® O 3, HOSTANOX®O 10, HOSTANOX®O 16, ULTRANOX® 210, ULTRANOX® 276, DOVERNOX® 10, DOVERNOX® 76, DOVERNOX® 3114, IRGANOX® 1010 or IRGANOX® 1076, or a phosphonate, such as IRGAMOD® 195. The secondary antioxidant can be trivalent phosphorus compounds, such as ULTRANOX® 626, DOVERPHOS® S-9228, HOSTANOX® P-EPQ or IRGAFOS 168.

It is also possible to introduce into the reactor, as polymerization additive, at least one compound capable of limiting unwanted etherification reactions, such as sodium acetate, tetramethylammonium hydroxide or tetraethylammonium hydroxide.

Recovery Step b)

The process comprises a step b) of recovery of the polyester on conclusion of the polymerization step. The polyester can be recovered by extracting it from the reactor in the form of a rod of molten polymer. This rod can be converted into granules using conventional granulation techniques.

Advantageously, the polyester thus recovered exhibits a solution reduced viscosity of greater than 40 ml/g and generally of less than 70 ml/g.

Optional Extrusion Step c)

The process can comprise an optional step c) of extrusion of the polyester obtained after the recovery step b).

The extrusion can be carried out in an extruder of any type, in particular a single-screw extruder, a co-rotating twin-screw extruder or a counter-rotating twin-screw extruder. However, it is preferred to carry out this extrusion step using a co-rotating extruder.

The extrusion step can be carried out:
by introducing the polymer recovered on conclusion of step b) into the extruder so as to melt said polymer;
by then introducing the nucleating agent into the molten polymer;
by then recovering the polyester obtained in the extrusion step.

During the extrusion, the temperature inside the extruder is regulated so as to be at a temperature greater than the melting point. The temperature inside the extruder can range from 150° C. to 320° C., preferably between 190 and 290° C.

This extrusion step can be carried out in the presence of a chain-extending agent. The chain extender is a compound comprising two functional groups capable of reacting, in reactive extrusion, with alcohol, carboxylic acid and/or carboxylic acid ester functional groups of the polymer of lower solution reduced viscosity. The chain extender can, for example, be chosen from compounds comprising two isocyanate, isocyanurate, lactam, lactone, carbonate, epoxy, oxazoline and imide functional groups, it being possible for said functional groups to be identical or different.

Step d) of Postcondensation by SSPC

The process for the preparation of the polyester according to the invention comprises a step d) of solid-phase postcondensation (SSPC). It is a step of increasing the molar mass by postpolymerization of a polymer of lower solution reduced viscosity, which comprises at least one 1,4:3,6-dianhydrohexitol (A) unit, at least one alicyclic diol (B) unit other than the 1,4:3,6-dianhydrohexitol (A) units and at least one terephthalic acid (C) unit, said polymer of lower solution reduced viscosity being devoid of noncyclic aliphatic diol units or comprising a molar amount of noncyclic aliphatic diol units, with respect to all of the monomeric units of the polymer, of less than 5%.

According to this embodiment, success is achieved in obtaining a polyester exhibiting a particularly high solution reduced viscosity, for example of greater than 70 ml/g.

“Polymer of lower solution reduced viscosity” is understood to mean a polyester exhibiting a solution reduced viscosity which is lower than that of the polyester obtained on conclusion of the postpolymerization step. This polymer can be obtained according to the processes described in the documents US2012/0177854 and Yoon et al., by using manufacturing processes using diols and terephthalic acid diesters as monomers, or by using the process of the first alternative form described above.

The SSPC is generally carried out at a temperature between the glass transition temperature and the melting point of the polymer. Thus, in order to carry out the SSPC, it is necessary for the polymer of lower solution reduced viscosity to be semicrystalline. Preferably, the latter exhibits a heat of fusion of greater than 10 J/g, preferably of greater than 30 J/g, the measurement of this heat of fusion consisting in subjecting a sample of this polymer of lower solution reduced viscosity to a heat treatment at 170° C. for 10 hours and in then evaluating the heat of fusion by DSC by heating the sample at 10 K/min.

Preferably, the polymer of lower solution reduced viscosity comprises:
a molar amount of 1,4:3,6-dianhydrohexitol (A) units ranging from 1% to 20%, advantageously from 5% to 15%;
a molar amount of alicyclic diol (B) units other than the 1,4:3,6-dianhydrohexitol (A) units ranging from 25% to 54%, advantageously from 30% to 50%;
a molar amount of terephthalic acid (C) units ranging from 45% to 55%.

Advantageously, according to this embodiment of the process, the SSPC step is carried out at a temperature ranging from 190 to 300° C., preferably ranging from 200 to 280° C.

The SSPC step can be carried out in an inert atmosphere, for example under nitrogen or under argon, or under vacuum.

Step of Introduction of at Least One Nucleating Agent

The process of the invention additionally comprises at least one step of introduction of at least one nucleating agent.

According to a first embodiment, the introduction of at least one nucleating agent is carried out during the synthesis a) of the polyester, in particular during step a1) described above.

According to a second embodiment, the introduction of at least one nucleating agent is carried out during extrusion c) of the polyester, when this step is not made optional.

According to another embodiment, the introduction of at least one nucleating agent can take place during the synthesis step a), and in particular during step a1), and during the extrusion step c) when this is not made optional.

The nucleating agent can be of different types, for example: organic acids, amides, carbon nanotubes, graphene derivatives, hydrazides, inorganic compounds, phosphate salts, polymeric nucleating agents, salts of carboxylic acids, sorbitol derivatives or xylan esters.

The nucleating agent is advantageously chosen from calcium silicate, nanosilica powder, talc, microtalc, kaolinite, montmorillonite, synthetic mica, calcium sulfide, boron nitride, barium sulfate, aluminum oxide, neodymium oxide, metal salt of phenylphosphonate, calcium carbonate, sodium carbonate, sodium benzoate, lithium benzoate, calcium benzoate, magnesium benzoate, barium benzoate, potassium benzoate, lithium terephthalate, sodium terephthalate, potassium terephthalate, calcium oxalate, sodium laurate, potassium laurate, sodium myristate, potassium myristate, calcium myristate, sodium octacosanoate, calcium octacosanoate, sodium stearate, potassium stearate, lithium stearate, calcium stearate, magnesium stearate, barium stearate, sodium montanate, calcium montanate, sodium toluoylate, sodium salicylate, potassium salicylate, lithium dicarbonate, sodium naphthalate, sodium cyclohexanecarboxylate, organic sulfonates, carboxylic acid amides, metal salts of phosphoric compounds of benzylidene sorbitol and their derivatives, sodium 2,2′-methylenebis(4,6-di(t-butyl)phenyl) phosphate, BRUGGOLEN® P282, sodium montanate and nitrogen-containing nucleating agents, such as sulfonamide metal salts, sulfonimide metal salts or ADK STAB® Na-05. Preferably, the nucleating agent is chosen from talc, sodium benzoate, calcium carbonate, sodium stearate, ADK STAB® Na-05, BRUGGOLEN® P282 and sodium montanate. More preferably, the nucleating agent is chosen from talc, sodium benzoate and ADK STAB® Na-05.

The nucleating agent is advantageously introduced in a proportion of between 0.01% and 2% by weight, with respect to the total weight of the components introduced during step a) of the process of the invention. Preferably, the nucleating agent is introduced in a proportion of between 0.05% and 1.75%, more preferably between 0.1% and 1.5%, more preferentially between 0.2% and 1.25%, more preferentially still between 0.25% and 1% by weight, with respect to the total weight of the components introduced during step a) of the process of the invention. Particularly preferably, the nucleating agent is introduced in a proportion of approximately 0.5% by weight, with respect to the total weight of the components introduced during step a) of the process of the invention.

The invention also relates to a composition comprising at least one polyester comprising 1,4:3,6-dianhydrohexitol units and one at least one nucleating agent. Such a composition comprises at least one polyester and at least one nucleating agent as described above with respect to the process according to the invention.

The polyester composition according to the invention can additionally comprise the polymerization additives optionally used during the process. It can also comprise other additional additives and/or polymers which are generally added during a subsequent thermomechanical mixing step.

Mention may be made, by way of example of an additive, of nanometric or non-nanometric, functionalized or nonfunctionalized, fillers or fibers of organic or inorganic nature. They can be silicas, zeolites, glass fibers or beads, clays, mica, titanates, silicates, graphite, calcium carbonate, carbon nanotubes, wood fibers, carbon fibers, polymer fibers, proteins, cellulose fibers, lignocellulose fibers and nondestructured granular starch. These fillers or fibers can make it possible to improve the hardness, the stiffness or the water- or gas-permeability. The composition can comprise from 0.1% to 75% by weight of fillers and/or fibers with respect to the total weight of the composition, for example from 0.5% to 50%. The additive of use in the composition according to the invention can also comprise opacifying agents, dyes and pigments. They can be chosen from cobalt acetate and the following compounds: HS-325 SANDOPLAST® Red BB (which is a compound carrying an azo functional group, also known under the name Solvent Red 195), HS-510 SANDOPLAST® Blue 2B, which is an anthraquinone, POLYSYNTHREN® Blue R and CLARIANT® RSB Violet.

The composition can also comprise, as additive, a processing aid, for reducing the pressure in the processing tool. A mold-release agent, which makes it possible to reduce the adhesion to the equipment for forming the polyester, such as molds and rolls of calendering devices, can also be used. These aids can be selected from fatty acid esters and amides, metal salts, soaps, paraffins or hydrocarbon waxes. Specific examples of these aids are zinc stearate, calcium stearate, aluminum stearate, stearamides, erucamides, behenamides, beeswax or candelilla wax.

The composition according to the invention can also comprise other additives, such as stabilizing agents, for example light-stabilizing agents, UV-stabilizing agents and heat-stabilizing agents, thinning agents, flame retardants and antistatic agents.

The composition can also comprise an additional polymer, different from the polyester according to the invention. This polymer can be chosen from polyamides, polyesters other than the polyester according to the invention, polystyrene, styrene copolymers, styrene/acrylonitrile copolymers, styrene/acrylonitrile/butadiene copolymers, polymethyl methacrylates, acrylic copolymers, poly(ether-imides), polyphenylene oxides, such as poly(2,6-dimethylphenylene oxide), polyphenylene sulfates, poly(ester-carbonates), polycarbonates, polysulfones, polyethersulfones, polyetherketones and the mixtures of these polymers.

The composition can also comprise, as additional polymer, a polymer which makes it possible to improve the impact properties of the polymer, in particular functional polyolefins, such as functionalized ethylene or propylene polymers and copolymers, core-shell copolymers or block copolymers.

The composition according to the invention can also comprise polymers of natural origin, such as starch, cellulose, chitosans, alginates, proteins, such as gluten, pea proteins, casein, collagen, gelatin, lignin, these polymers of natural origin being able or not being able to be physically or chemically modified. The starch can be used in destructured or plasticized form. In the latter case, the plasticizer can be water or a polyol, in particular glycerol, polyglycerol, isosorbide, sorbitans, sorbitol or mannitol, or also urea. The process described in the document WO 2010/010282 A1 can in particular be used to prepare the composition.

The composition according to the invention can be obtained directly by the process according to the invention on conclusion of step b) for recovery of the polyester comprising 1,4:3,6-dianhydrohexitol units or manufactured from this polyester, in particular when the composition comprises one or more additional polymers and/or one or more additives as described above. In the latter case, the composition according to the invention can be prepared by conventional methods of mixing thermoplastics. These conventional methods comprise at least one step of mixing the polymers in the molten or softened state and a step of recovery of the composition. This process can be carried out in paddle or rotor internal mixers, external mixers, or single-screw or twin-screw co-rotating or counter-rotating extruders. However, it is preferred to carry out this mixing by extrusion, in particular by using a co-rotating extruder.

The mixing of the constituents of the composition can take place under an inert atmosphere.

In the case of an extruder, the various constituents of the composition can be introduced by means of feed hoppers located along the extruder.

The invention also relates to a finished or semifinished plastic article comprising the composition according to the invention.

This article can be of any type and can be obtained by using conventional transformation techniques.

It can, for example, concern fibers or yarns of use in the textile industry or other industries. These fibers or yarns can be woven, to form fabrics, or also nonwoven.

The article according to the invention can also be a film or a sheet. These films or sheets can be manufactured by calendering, cast film extrusion, film blowing extrusion techniques, followed or not followed by monoaxial or polyaxial drawing or orientation techniques. These sheets can be thermoformed or injection molded in order to be employed, for example, for parts such as machine ports or hoods, the bodies of various electronic devices (telephones, computers, screens), or else as impact-resistant panes.

The article can also be transformed by extrusion of profiled elements which can find their application in the building and construction fields.

The article according to the invention can also be a container for transporting gases, liquids and/or solids. These can be baby's bottles, flasks, bottles, for example bottles for carbonated or noncarbonated water, juice bottles, soda bottles, carboys or bottles for alcoholic beverages, small bottles, for example medicine bottles or cosmetic product bottles, it being possible for these small bottles to be aerosols, dishes, for example for ready-made meals, microwave dishes or also lids. These containers can be of any size. They can be manufactured by extrusion blow-molding, thermoforming or injection blow-molding.

These articles can also be optical articles, that is to say articles requiring good optical properties, such as lenses, disks, transparent or translucent panels, light-emitting diode (LED) components, optical fibers, films for LCD screens or also window panes. These optical articles exhibit the advantage of being able to be placed close to sources of light and thus of heat, while retaining excellent dimensional stability and good resistance to light.

Mention may also be made, among the applications of the article, of protective parts where the impact strength is important, such as cell phone protective features, spherical packaging, but also, in the automotive field, fenders, as well as elements of the dashboard.

The articles can also be multilayer articles, at least one layer of which comprises the polymer or the composition according to the invention. These articles can be manufactured by a process comprising a coextrusion step in the case where the materials of the different layers are brought into contact in the molten state. Mention may be made, by way of example, of the techniques of tube coextrusion, profiled element coextrusion, coextrusion blow-molding of a bottle, a small bottle or a tank, generally combined under the term “coextrusion blow-molding of hollow bodies”, blown film coextrusion, also known as film blowing coextrusion, and cast coextrusion.

They can also be manufactured according to a process comprising a step of application of a layer of molten polyester to a layer based on organic polymer, on metal or on adhesive composition in the solid state. This step can be carried out by pressing, by overmolding, lamination, extrusion-lamination, coating, extrusion-coating or spreading.

The invention is also described in the examples below, which are meant to be purely illustrative and do not in any way limit the scope of the present invention.

### EXAMPLES

### Example 1

In this example, a poly(isosorbide-co-cyclohexylene terephthalate) comprising 10.1 mol % of isosorbide with respect to all of the monomer units and with IV=51 ml/g is extruded with different nucleating agents introduced in a proportion of 0.5% by weight.

Prior to the extrusion, the polymer is dried in an oven under vacuum at 80° C. overnight. Then 16 g of granules were mixed manually in a beaker with 0.5 w % of nucleating agent. The mixture was then placed in a DSM twin-screw microextruder under nitrogen and at 270° C. for 10 min. The crystallization kinetics were subsequently measured by DSC. First of all, the samples are melted rapidly at 280° C. for 2 minutes. The temperature is then rapidly reduced to 190° C. for the time necessary for the maximum crystallization of the sample. The time necessary in order to obtain 50% of the maximum crystallization of the sample is recorded as t_{1/2}.

The rate of crystallization of the polymers extruded with each of the nucleating agents is measured and compared with the rate of crystallization of a polymer extruded without a nucleating agent. The results are presented in table 1.

TABLE 1

| Nucleating agent (0.5% by weight) | t_{1/2} (min) |
|---|---|
| ADK STAB ® Na-05 | 4.2 ± 0.6 |
| Sodium benzoate | 3.5 ± 0.3 |
| Talc | 3.0 ± 0.3 |
| Polymer of Ex. 1 unmodified unmodified | 29.8 ± 1.1 |
| by extrusion | |

These results show that the presence of a nucleating agent during the extrusion makes it possible to accelerate the kinetics of crystallization of poly(isosorbide-co-cyclohexylene terephthalate).

### Example 2

In this example, nucleating agents were directly added during the synthesis of poly(isosorbide-co-cyclohexylene terephthalate) comprising 10.2 mol % of isosorbide with respect to all of the monomers. The nucleating agents were added in a proportion of 0.5% by weight with respect to the final weight of the polymer.

1800 g of terephthalic acid, 546 g of isosorbide, 1179 g of 1,4-cyclohexanedimethanol, 14.9 g of talc Steamic 00SF (Imerys), 1.24 g of dimethyltin oxide and 1.5 g of Irganox 1010 are introduced into a 7.5 l reactor. In order to extract the residual oxygen from the isosorbide crystals, 4 vacuum-nitrogen cycles are carried out once the temperature of the reaction medium is between 60 and 80° C. The reaction mixture is subsequently heated to 275° C. (4° C./min) under 6.6 bar of pressure and with continual stirring (150 rpm). The degree of esterification is estimated from the amount of distillate collected. The pressure is then reduced to 0.7 mbar over 90 minutes according to a logarithmic gradient and the temperature is brought to 285° C. These vacuum and temperature conditions were maintained until a torque increase of 11 Nm with respect to the initial torque was obtained. Finally, a string of polymer is run out through the bottom valve of the reactor, cooled in a tank of water thermally regulated at 15° C. and cut up into the form of granules of approximately 15 mg.

The resin thus obtained has a solution viscosity of 50.8 ml/g. The ¹H NMR analysis of the polyester shows that it contains 12.4 mol % of isosorbide with respect to all of the monomer units. The crystallization kinetics were subsequently measured by DSC. First of all, the samples are melted rapidly at 280° C. for 2 minutes. The temperature is then rapidly reduced to 190° C. for the time necessary for the maximum crystallization of the sample. The time necessary in order to obtain 50% of the maximum crystallization of the sample is recorded as t_{1/2}. The temperatures and enthalpies of hot crystallization obtained from the melt by nonisothermal crystallization at 10° C./min are given in table 2.

The rate of crystallization of the polymers synthesized with each of the nucleating agents is measured and compared with the rate of crystallization of a polymer synthesized without a nucleating agent. The results are presented in table 2.

TABLE 2

| Nucleating agent | IV | mol % | t_{1/2} | Tmc | ΔHmc |
|---|---|---|---|---|---|
| (0.5% by weight) | (ml/g) | ISO | (min) | (° C.) | (J/g) |
| Polymer of example 2 | 50.8 ml/g | 10.1 | 3.5 | 168.7 | 4.29 |
| Polymer identical to | 51.2 ml/g | 9.9 | 29.8 | NO | NO |
| example 2 but without | | | | | |
| talc | | | | | |

NO: Not observed.

These results show that the presence of a nucleating agent during the synthesis makes it possible to accelerate the kinetics of crystallization of the poly(isosorbide-co-cyclohexylene terephthalate).

1. A process for the preparation of a polyester of poly(1,4:3,6-dianhydrohexitol-co-cyclohexylene terephthalate) type, said process comprising the steps of:
a) synthesis of said polyester by oligomerization and then polycondensation;
b) recovery of the polyester;
c) optional extrusion of said polyester; and
d) sold-phase postcondensation SPPC of said polyester;
wherein said process additionally comprises at least one step of addition of at least one nucleating agent.

2. The process as claimed in claim 1, wherein the synthesis of the polyester in step a) is carried out starting from at least one 1,4:3,6-dianhydrohexitol (A), at least one alicyclic diol (B) other than the 1,4:3,6-dianhydrohexitols (A) and at least one terephthalic acid (C), the molar ratio ((A)+(B))/(C) advantageously ranging from 1.05 to 1.5, said monomers being devoid of noncyclic aliphatic diol or comprising, with respect to all the monomers introduced, a molar amount of noncyclic aliphatic diol units of less than 5%.

3. The process as claimed in claim 1, wherein the step of introduction of the nucleating agent is carried out during step a).

4. The process as claimed in claim 1, comprising step c) of the extrusion of the polyester of the polyester after step b) and wherein the step of introduction of the nucleating agent is carried out during this extrusion step.

5. The process as claimed in claim 1, in which the nucleating agent is introduced in a proportion of between 0.01% and 2% by weight, with respect to the total weight of the components.

6. A composition, comprising a polyester of poly(1,4:3,6-dianhydrohexitol-co-cyclohexylene terephthalate) type and one at least one nucleating agent.

7. The composition as claimed in claim 6, wherein the proportion of the nucleating agent is between 0.01% and 2% by weight, with respect to the total weight of the composition.

8. A plastic article, comprising the composition as claimed in claim 6.
